(19) United States
(12) Patent Application Publication
(10) Pub. No.: US 2013/0103543 A1
(43) Pub. Date: Apr. 25, 2013

(54) SYSTEMS AND METHODS FOR GENERATING DATA FEEDS

(71) Applicants: Christian Probst, Ottawa (CA); Jason Graham, Ottawa (CA)

(72) Inventors: Christian Probst, Ottawa (CA); Jason Graham, Ottawa (CA)

(21) Appl. No.: 13/277,363

(22) Filed: Oct. 20, 2011

(51) Int. Cl. G06Q 30/02; G06Q 50/16

(52) U.S. Cl. 705/26.41

(57) ABSTRACT

Systems and methods for generating a customized data feed of real estate listing data for provision to destination websites, and for retrieving and displaying resulting web traffic.

### FIELD

Embodiments described herein relate to systems and methods for generating data feeds, and in particular, to systems and methods for generating data feeds of real estate listing data.

### INTRODUCTION

Buyers and sellers of real estate properties may use a real estate agent or broker to buy and sell real estate properties. A real estate agent or broker may be affiliated with real estate associations, such as a brokerage, a franchise, a local association, a provincial association, and a national association. Real estate agents or brokers may facilitate real estate property sales by providing and accessing real estate listing data, such as text descriptions, images, videos, and so on. A real estate agent and other parties associated with real estate may provide buyers and sellers with a data service such as a website with real estate listing information.

### SUMMARY

In a first aspect, embodiments described herein provide a method for electronically communicating real estate listing data feeds, the method comprising:
creating a plurality of listing records for a corresponding plurality of real estate properties, wherein each listing record comprises real estate listing data and a plurality of permissions attributes defining permissions data;
storing the plurality of listing records in a listing content repository;
registering a plurality of destination websites, wherein each destination website is associated with a permission level;
defining an access module associated with a portion of the destination websites, the portion of the destination websites having at least one common permission level, wherein the access module determines, by a computer processor, a subset of the listing records, wherein the subset of the listing records is determined by filtering the plurality of listing records by comparing the at least one common permission level and the permissions attributes in each listing record;
generating a data feed comprising selected real estate listing data, wherein the selected real estate listing data is generated from the subset of listing records; and
providing the generated data feed to the destination website.

In some embodiments the method further comprises:
receiving at least one criterion associated with a destination website of the portion of destination websites, wherein the at least one criterion relates to the real estate listing data; and wherein the selected real estate listing data is generated by applying the at least one criterion against the subset of listing records.

The least one criterion may be a transaction type, price, property type, ownership type, owner, waterfront status, geographic location, or a combination thereof.

The data feed may be generated and provided to the destination website on a periodic basis.

In some embodiments, the method may involve registering a user associated with one or more destination websites. The user may be associated with a role indicating whether the user is permitted to provide the at least one criterion for the destination website. A user may be associated with a listing record, and associated with a role indicating whether the user is permitted to set the permissions attributes for the listing record.

In some embodiments, the method may involve tracking traffic and usage statistics for destination websites and aggregating the traffic and user statistics in a reporting repository.

In some embodiments, the method may involve generating traffic and usage reports for destination websites using the reporting repository.

The access module may be a data pool such as a national shared pool, a franchisor pool, a member pool, and a third party pool.

In another aspect, embodiments described herein may provide a system for electronically communicating real estate listing data for provision to destination websites, comprising:
a listing content repository comprising a plurality of listing records for a corresponding plurality of real estate properties, wherein each listing record comprises real estate listing data and a plurality of permissions attributes defining permissions data;
a distribution engine configured to:
   register a plurality of destination websites, wherein each destination website is associated with a permission level;
   generate a data feed comprising selected real estate listing data; and
   provide the generated data feed to a destination website; and
a permission management module configured to define an access module associated with a portion of the destination websites, the portion of the destination websites having at least one common permission level, wherein the access module determines, by a computer processor, a subset of the listing records, wherein the subset of the listing records is determined by filtering the plurality of listing records by comparing the at least one common permission level and the permissions attributes in each listing record;
   the selected real estate listing data being generated from the subset of listing records.

In some embodiments, the distribution engine may be configured to receive at least one criterion associated with a destination website of the portion of destination websites. The criterion relates to the real estate listing data. The selected real estate listing data may be generated by applying the at least one criterion against the subset of listing records. The criteria is configurable and may include transaction type such as sale and rent/lease; price such as a maximum amount and a minimum amount; property type selected from the group consisting of residential, recreational, land, agriculture, parking, commercial; ownership type; waterfront status; and geographic location.

The data feed may be generated and provided to the destination website on a periodic basis.

A user associated with one or more destination websites may be registered. The user may be associated with a role indicating whether the user is permitted to provide the at least one criterion for the destination website. The user may also be associated with a listing record and a role indicating whether the user is permitted to set the permissions attributes for the listing record.

In some embodiments, the system further comprises an analytics data module for tracking traffic and usage statistics for destination websites and aggregating the traffic and user statistics in a reporting repository; and generating traffic and usage reports for destination websites using the reporting repository.

In some embodiments, the system further comprises a security module for authenticating a user prior to receiving the criterion from the user.

### DRAWINGS

For a better understanding of embodiments of the systems and methods described herein, and to show more clearly how they may be carried into effect, reference will be made, by way of example, to the accompanying drawings in which:

FIG. 1 illustrates a block diagram of a system for electronically communicating real estate listing data feeds in accordance with embodiments described herein;

FIG. 2 illustrates a block diagram of a system electronically communicating real estate listing data feeds in accordance with other embodiments described herein;

FIG. 3 illustrates a block diagram of a method electronically communicating real estate listing data feeds in accordance with embodiments described herein; and

FIG. 4 illustrates a block diagram of further details of a method electronically communicating real estate listing data feeds in accordance with embodiments described herein

The drawings, described below, are provided for purposes of illustration, and not of limitation, of the aspects and features of various examples of embodiments described herein. The drawings are not intended to limit the scope of the applicants' teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein, but rather as merely describing implementation of the various embodiments described herein.

The embodiments of the systems and methods described herein may be implemented in hardware or software, or a combination of both. However, these embodiments may be implemented in computer programs executing on programmable computers, each computer including at least one processor, a data storage system (including volatile and non-volatile memory and/or storage elements), and at least one communication interface. For example, the programmable computers may be a server, network appliance, set-top box, embedded device, computer expansion module, personal computer, laptop, personal data assistant, or mobile device. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. USB, flash, ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Large networks such as the Internet enable distribution of real estate listings to a wide audience through the use of websites that provide real estate listing information. Individuals and organizations associated with real estate can create their own websites, referred to herein as destination websites.

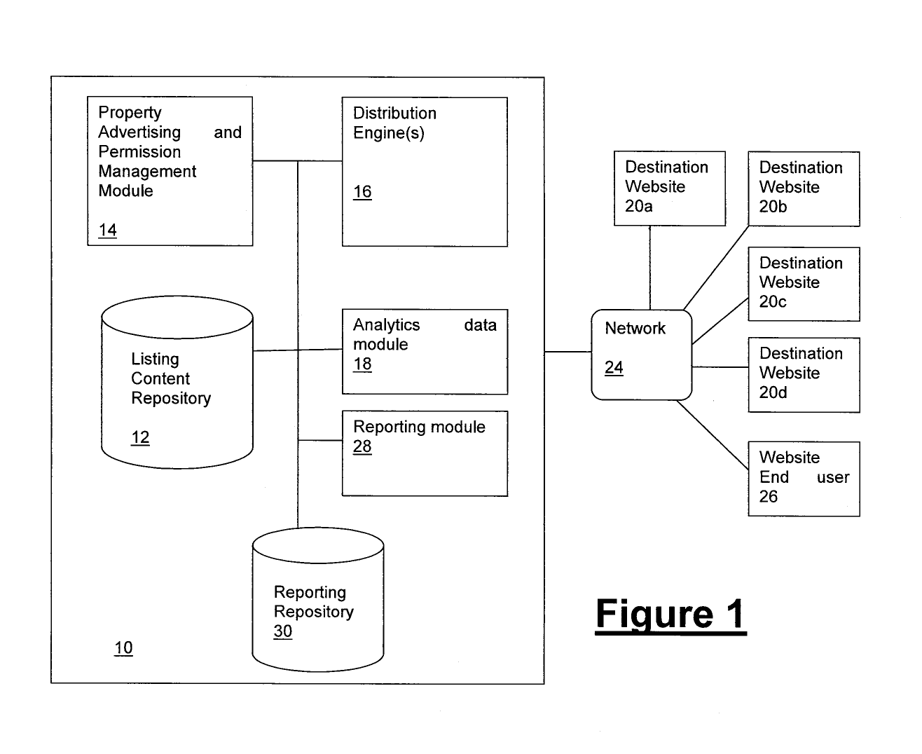

Referring now to FIG. 1, there is shown a block diagram of a system 10 for generating customized data feeds of real estate listing data in accordance with embodiments described herein.

System 10 is operable to register any suitable number of destination websites 20. For clarity, FIG. 1 shows four destination websites 20a, 20b, 20c, 20d which may receive data feeds of real estate listing data stored in a listing content repository 12. The data feeds may be used to populate the destination websites 20a, 20b, 20c, 20d with real estate listing data. System 10 is operable to generate data feeds of real estate listing data stored in the listing content repository 12 and provide the data feeds to destination websites 20a, 20b, 20c, 20d via network 24. The destination websites 20a, 20b, 20c, 20d are accessible to website end users 26 via a network. To provide timely and up to date real estate listing data, system 10 is configured to periodically provide updated data feeds to ensure that the real estate listing data provided to the destination websites 20a, 20b, 20c, 20d is up to date. Web servers (not shown) for the destination websites 20a, 20b, 20c, 20d may be dynamically or manually updated based on updated data feeds. The update may be initiated by push or pull technology, of a combination thereof.

System 10 may be implemented by one or more servers with computing processing abilities provided by a processor and memory such as database(s) or file system(s). Although only one system 10 is shown for clarity, there may be multiple systems 10 or servers distributed over a wide geographic area and connected via a network. System 10 has a network interface for connecting to network 24 in order to communicate with destination websites 20a, 20b, 20c, 20d and other components and to provide data feeds and other computing applications.

System 10 is operable to generate data feeds. A data feed is a mechanism for destination websites 20a, 20b, 20c, 20d to receive updated data from a data source. A data feed may have a data structure and may be a file made up of raw data representing real estate listings. Web servers implementing the destination websites 20a, 20b, 20c, 20d process the received data feeds to update the real estate listing content provided therein. A data feed may be implemented in a variety of different data formats such as RSS, atom, XML, other XML based formats, comma separated values (CSV) and so other technical languages.

The destination websites 20a, 20b, 20c, 20d and web servers associated therewith may be managed by a real estate broker, a real estate agent, a real estate franchise, a member of a real estate association, a third party providing real estate related services, and so on. A real estate agent or broker is a licensed real estate practitioner that represents sellers and buyers of real estate transactions and can collect commissions. A real estate broker or agent is a party who acts as an intermediary between sellers and buyers of real estate. A real estate firm, such as a brokerage, is a company or office employing real estate agents, brokers, and so on. A real estate firm may use a franchise model to provide service to the public Typically, real estate agents, real estate firms, real estate brokers, and real estate franchises are members of real estate associations, such as local real estate associations, provincial real estate associations and a national real estate association, such as the Canadian Real Estate Association. Accordingly, destination websites 20a, 20b, 20c, 20d may be managed by an individual, company or association involved in real estate including real estate agents, real estate brokers, firms, brokerages, franchises, associations, third parties, marketing provider, advertising service provider, and the like. System 10 is configured to periodically provide updated data feeds of real estate listing data to destination websites 20a, 20b, 20c, 20d based on real estate listing data stored in the listing content repository 12 that is received from agents, brokers, franchises, associations and an aggregate thereof.

The destination websites 20a, 20b, 20c, 20d may reside on a server system (not shown) or other computing devices having a processor and memory, such as a personal computer, workstation, server, portable computer, mobile phone, personal digital assistant, laptop, smart phone, WAP phone, or a combination of these, with network interfaces for connecting to network 24 in order to communicate with system 10. The destination websites 20a, 20b, 20c, 20d may be implemented by one or more web servers (not shown).

Network 24 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

System 10 includes a listing content repository 12, a property advertising and permission management module 14 and one or more distribution engines 16. In accordance with some embodiments, system 10 includes an analytics data module 18, reporting module 28 and a reporting repository 30, which may be connected to, or part of, the listing content repository 12.

The listing content repository 12 may be implemented by one or more servers with computing processing abilities provided by a processor and memory such as database(s) or file system(s). Although only one listing content repository 12 is shown for clarity, there may be multiple listing content repositories 12 distributed over a wide geographic area and connected via e.g. network 24. The listing content repository 12 stores and manages real estate listing records. Each record pertains to a particular real estate property. A real estate listing record maintains attributes and corresponding data values defining data associated with a real estate listing. Examples include text data values, image data values, video data values, and various attributes such as listing ID, created date, owner (e.g. real estate agent, broker and brokerage), photos, floorplan, permissions, status, and so on. Permissions attributes may define different levels of permissions associated with the real estate listing. The owner of the real estate listing may specify permissions, such as by specifying one or more individuals (such as a real estate agent or broker) or group (such as a brokerage) permitted to view and access the real estate listing. The different levels of permissions may associate a type of user with a subset of listing data that the type of user is permitted to view, access, make advertising decisions, manage, and so on. The subset of accessible data may vary depending on the type of user.

The property advertising and permission management module 14 manages real estate listing data stored in the listing content repository 12, and also manages permissions associated with the real estate listing data. Each destination website will be assigned an associated permission level which is used when generating the corresponding data feed. The property advertising and permission management module 14 correlates permissions attributes of real estate listing records to the permission level assigned to the destination website to generate an appropriate data feed. The property advertising and permission management module 14 receives data relating to real estate listings, stores said data in the listing content repository 12, and configures permissions attributes for said data. The permissions attributes for a given real estate listing record may be modified and reviewed.

The distribution engine 16 generates customized data feeds of real estate listings from the real estate listing data stored in the listing content repository 12. The distribution engine 16 may generate customized data feeds of real estate listings based on criteria received from destination websites 20a, 20b, 20c, 20d. The distribution engine 16 interacts with the property advertising and permission management module 14 to comply with the permission attributes associated with the real estate listing data when generating customized data feeds for destination websites 20a, 20b, 20c, 20d. The distribution engine 16 is further operable to generate different formats of data feeds depending on the corresponding destination website 20a, 20b, 20c, 20d.

The analytics data module 18 tracks traffic and usage statistics for destination websites 20a, 20b, 20c, 20d and aggregates and stores the traffic and usage data in the reporting repository 30. The reporting module 28 can then access the aggregated traffic and usage data stored in the reporting repository 30 to generate reports regarding the traffic and usage statistics for destination websites 20a, 20b, 20c, 20d. The analytics data module 18 analyzes usage data for generating reports for destination websites. For example, the analytics data module 18 may collect usage data on the number of times a website end user 26 clicks on a specific real estate listing, a link requesting more information, a listing details link, an e-mail link and so on. Data may be collected for a specified time period. The analytics data module 18 is operable to maintain historical statistics and the reporting module 28 is operable to generate reports of historical statistics. The statistics may be provided on a per listing basis or on a per destination website basis 20. The destination website 20 may be configured to provide an analytic data feed of its usage data to system 10 for provision to the analytics data module 18 and storage in the reporting repository 30. The reporting module 28 can generate reports by filtering the usage data based on specific factors such as a period of time. The reporting module 28 is operable to receive ad hoc queries and generate a statistics report on an on-demand basis.

In accordance with some embodiments described herein, system 10 comprises a security module (not shown) configured to authenticate a user that wishes to access system 10, such as by verifying the user's identity for example. Security module may implement other security techniques such as encryption, digital signing, and so on to protect data and maintain integrity of the data for system 10.

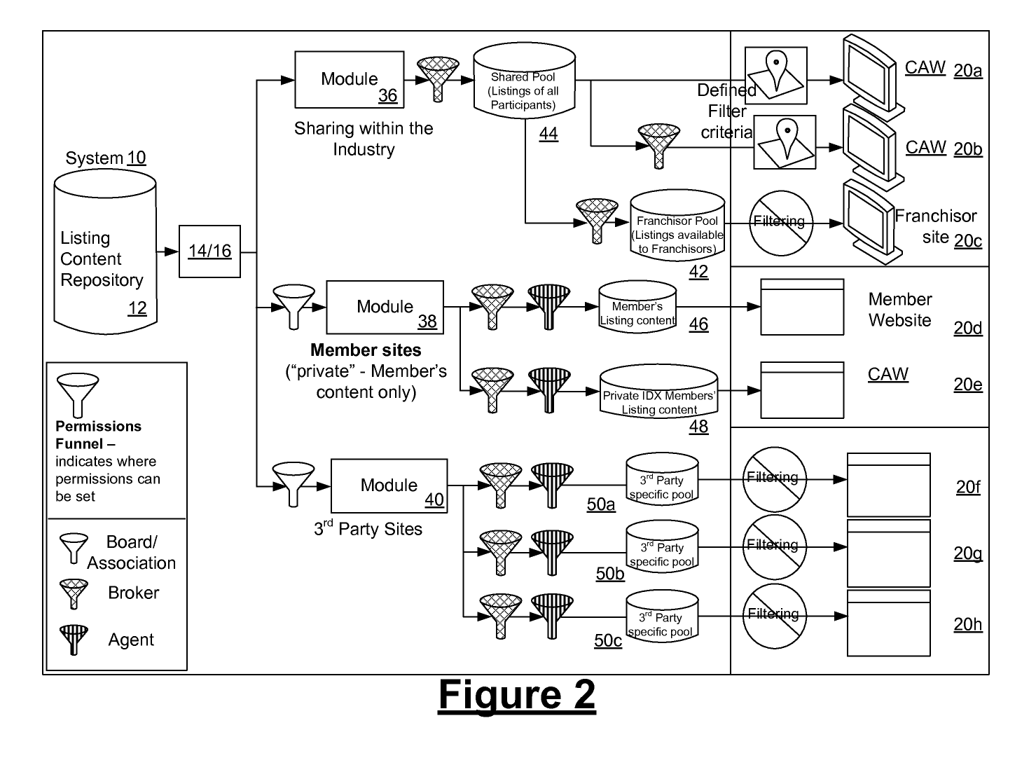

FIG. 2 illustrates a block diagram of another system 10 for generating a customized data feed of real estate listing data in accordance with embodiments described herein. Like parts have been assigned like references numbers and may not be further described in detail.

System 10 includes a listing content repository 12, a property advertising movement permission management module 14, and one or more distribution engines 16.

System 10 may also include an interface module (not shown) to receive real estate listing data for storage in the content listing repository 12 as listing records. The interface module may also be used to configure attributes relating to the real estate listing records. A real estate agent may use the interface module to upload real estate listing data to the listing content repository 12. System 10 uses real estate listing records to collect and store data and attributes pertaining to particular real estate properties. For example, a real estate listing record may include attributes or fields (referred to as listing attributes) defining data about the particular real estate property. The listing attributes may include data labels such as the price, number of bedrooms, dimensions, description of the property, inclusions, exclusions and so on, and the corresponding data values, such as the actual price of the property, the actual number of bedrooms of the property, and so on. Listing attributes may also include images and videos of the piece of real estate including floor plans, photos, and architectural drawings, and other. Further listing attributes include listing ID, created date, owner (by real estate agent, broker and brokerage), permission attributes, status, and so on. The interface module may be used to configure the listing attributes, including the permissions attributes, when real estate listing data for the listing record is uploaded to system 10. For example, an owner of a real estate listing may use interface module to make real estate listing data pertaining to a particular real estate property accessible to everyone. System 10 defines this in a permission attribute for the corresponding listing record. In other instances, the owner may use interface module to limit access to real estate listing data pertaining to particular real estate properties, and system 10 defines this in a permission attribute for the corresponding listing record. As another example, an owner may use interface module to make a subset of real estate listing data in a real estate listing record about a particular estate property available to everyone using the system 10, but may limit access to the remaining subset of real estate listing data in the real estate record, such as a detailed video of the particular real estate property, for example. Limited access may still be provided to a select group of participants, or in some cases, no access will be permitted at all.

System 10 distributes data feeds to multiple destination websites 20a, 20b, 20c, 20d, 20e, 20f, 20g, 20h which are web sites created by individuals and organizations associated with real estate, such as real estate broker websites, real estate agent websites, members of real estate associations websites, franchises website, cooperative advertising (CAW) websites, private CAW websites, third party websites, and so on.

A broker website may be a destination website 20a displaying listings of a single real estate broker, for example. A member website may be a destination website 20b displaying listings of a single real estate agent, listing pool or other member, for example. FIG. 2 provides an example member website, and others may be implemented. A member may be a broker, a sales person. A franchisor website may be a destination website 20c displaying listings of a single franchise, for example. Those real estate individuals and organizations that are part of a real estate association such as real estate brokers, real estate agents, real estate franchises, may be referred to as real estate participants or members. A CAW may be a destination website that provides users with the ability to search through real estate listings of other real estate participants. A private CAW website is similar to a CAW website except that it is restricted to real estate listings provided by real estate participants that have formed a sharing agreement. Destination websites also include a broker CAW website 20a and a member CAW website 20b that provides users with the ability to search through real estate listings that the broker and member are permitted to access. A third-party destination website 20f/g/h may be an external listing publishing site that is not part of a real estate association but still provides real estate related services to the public, such as real estate advertising services.

System 10 may include access modules to control and manage permissions associated with the real estate listings. Example access modules include an industry module 36, a member module 38, and a third party module 40.

The industry module 36 is operable to determine and manage a national shared pool 44 and a franchise pool 42.

The national shared pool 44 is a subset of real estate listing data from the listing content repository 12 that may be shared amongst a predetermined group of real estate participants. The real estate listing data may be shared based on agreements entered into by real estate participants. For example, a real estate brokerage may ‘opt in’ some or all of their real estate listings to be shared by the national shared module 44 with other real estate brokers and agents. A brokerage ‘opting in’ their listings may, in turn, be provided with access to all other real estate listing data in by the national shared pool 44. Access by a brokerage may also extend to its real estate brokers and agents. A brokerage may by default ‘opt-in’ all of its real estate listings and then may ‘opt out’ specific listings from the national shared pool 44, when directed by the seller, for example. When a brokerage decides to ‘opt-out’ all of their listings then all of their listings may be excluded from the national share pool 44, and then in some embodiments, the brokerage may not have access to the national share pool.

For each real estate listing record in the listing content repository 12, system 10 may associate a permission attribute for the national share pool 44 which will indicate whether the respective real estate listing record is an ‘opt-in’ or ‘opt-out’ of the national shared pool 44. Industry module 36 may maintain the national shared pool 44 by filtering out all real estate listing records in the content repository 12 with the permission attribute set to ‘opt-out’. The permission attribute may be set or modified via interface module.

System 10 is operable to register destination websites 20a/b to receive data feeds from real estate listing data stored in the national shared pool 44. For example, a brokerage that has ‘opted in’ their listings to the national shared pool 44 may provide access to destination websites 20a/b associated with their real estate brokers and agents, such as a broker CAW website and a member CAW website. If a brokerage has ‘opted-out’ their listings to the national share pool 44 then they may not have access to the national shared pool 44 In turn, destination websites 20a associated with real estate brokers and agents of the brokerage may also not have access to national shared pool 44.

As described herein, destination websites 20a/b are shown to be examples of specifying criteria for data feeds based on attributes of the real estate listings and data values.

The franchisor pool 42 is a subset of the real estate listing data from the national shared module 44 that may be accessed by real estate franchises. The real estate listing data may be shared in the franchisor pool 42 based on agreement of real estate participants. For example, a real estate brokerage may ‘opt-in’ or ‘opt-out’ their real estate listings from the franchisor pool 42. If a real estate listing is opted in to the franchisor pool then it may be included in the franchisor pool 42. If a real estate listing is opted out of the franchisor pool that it will be excluded from the franchisor pool 42. Destination website 20c associated with a franchisor may access the real estate listing data from the franchisor pool 42. In accordance with some embodiments, the franchisor pool 42 is a subset of real estate data from the national shared module 44, so a brokerage may have to opt in their real estate listings with the national shared pool 44 in order to opt in those real estate listings to the franchise pool 42.

For each real estate listing record in the listing content repository 12, system 10 may associate permissions for the franchise pool 42 which will indicate whether the respective real estate listing record is an ‘opt-in’ or ‘opt-out’ of the franchise pool 42. Industry module 36 may maintain the franchise pool 42 by filtering out all real estate listing records in the national shared pool 44 with the permission attribute for the franchise pool 42 set to ‘opt-out’. The permission attribute for the franchise pool 42 may be retrieved and modified via interface module. Similar to the national shared pool 44, system 10 is operable to register destination website 20c to receive data feeds from real estate listing data stored in the franchise pool 42. An example destination website 20c includes a franchisor website. In this example, the franchisor may not specify criteria for the data feed and may receive all listings in the franchisor pool 42 in a data feed.

The data feeds for the destination websites 20a are then generated from the real estate listings in the national shared pool 44 and the franchisor pool 42 based on criteria specified by the destination websites 20a. That is, the specified criteria received by system 10 is applied to the national shared pool 44 and the franchisor pool 42 to generate data feeds for destination websites 20a registered to access either the national shared pool 44 or the franchisor pool 42. The specified criteria may relate to attributes and data values associated with the real estate listing data.

The member module 38 manages content pools relating to member destination websites 20d/e, such as a member listing content pool 46 and a private CAW listing content pools 48, for example.

A members listing content pool 46 manages real estate listing data associated with a specific member of a real estate association, such as real estate agent for example. A member website may be a destination website 20d/e that only displays listings of a particular member, for example. System 10 registers a destination website for a member to receive customized data feeds of only the member's real estate listings. The member may also be associated with a brokerage and in such case system 10 may require the brokerage to opt in the specific member and grant permission to register a destination website for the specific member. After system 10 registers a destination website for a specific member, then the system 10 generates a member listing content pool 46 of that member's real estate listing data to generate data feeds for that member's destination website. In accordance with some embodiments, by default system 10 may include all real estate listing data associated with that member in the member listing content pool 46. In other embodiments, system 10 may permit the member to ‘opt out’ specific real estate listing data from their member listing content pool 46 to exclude the specific real estate listing data in the data feeds for the member's destination website 20b.

The CAW listing content pool 48 manages real estate listing data associated with a private CAW website. A private CAW website may provide a real estate listing search that enables users to search through real estate listings associated with other real estate participants that have granted permission to the owner of said CAW to advertise the real estate listings on its website.

System 10 registers a destination website as a private CAW website to receive customized data feeds of real estate listings associated with other real estate participants that have agreed to contribute some or all of their listings to the CAW pool. The CAW website may be affiliated with an individual, such as a real estate agent, or group, such as a brokerage. After system 10 registers the CAW website then system 10 generates a CAW members listing content pool 48 to generate data feeds for that CAW website. The operator of the CAW website may define the scope of real estate listings that should be included (i.e. opted in) and excluded (i.e. opted out) from the CAW members listing content pool 48. The operator may be an owner of real estate listings, or affiliated therewith. For example, a brokerage may operate a CAW website that includes by default all of the real estate listings associated with the brokerage. A real estate participant (such as a real estate agent or brokerage) may opt in or opt out from including such participants listings in a CAW members listing content pool based on a seller's directions, and other factors. For example, a brokerage may opt out of including a specific real estate listing based on a seller's direction.

The system 10 is operable to manage permissions associated with the contribution of listings to a specific CAW pool. System is also operable to manage permissions for CAW websites based on specific opt in and opt out options associated with the IDX website. System 10 maintains a CAW member permission attribute for each real estate listing record indicating the ‘opt in’ or ‘opt out’ selection of the CAW members listing content pool 48. System 10 is operable to generate the CAW members listing content pool 48 by determining a subset of real estate listing records in the listing content repository 12 associated with the content pool. System 10 then is operable to filter out all real estate listing records having an associated CAW member permission attribute set to ‘opt out’.

System 10 is operable to send electronic invitations with a request to join a CAW member listing content pool 48, on the request of a real estate participant such as a real estate agent or brokerage. After accepting the request, system 10 enables the excepting user to opt in or opt out some or all of their real estate listings to the CAW member listing content pool 48.

The third party module 40 manages third-party content pools 50a, 50b, 50c specific to third-party websites. System 10 is operable to register a third-party website 20f/g/h to receive data feeds based on real estate listing data accessible to the third-party associated with the website. After system 10 registers the third-party website, system 10 generates a third-party content pool 50a to generate data feeds for that third-party website. System 10 is operable to manage permissions for third-party websites using the permissions attributes associated with the real estate listing records. For example, system 10 is operable to manage a third-party commission attribute with an opt in or opt out flag depending on whether a particular real estate listing record is accessible by some or all third parties.

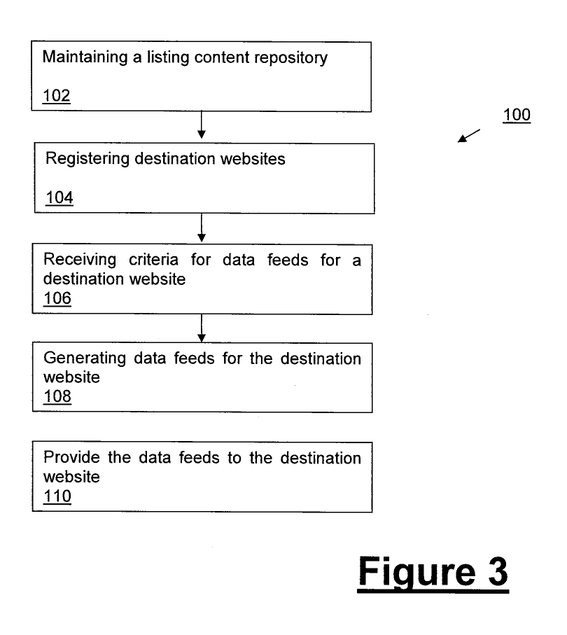

FIG. 3 illustrates a block diagram of a method for generating a customized data feed of real estate listing data in accordance with embodiments described herein.

At step 102, system 10 maintains a listing content repository 12. The listing content repository 12 contains data structures that define real estate listing records. A real estate listing record contains listing attributes (i.e. data fields or attributes) which store data about real estate properties. As described herein, the listing attributes include labels and corresponding data values, such as text data, image data, video data, and so on. The record may also have listing attributes such as owner and specific permission controls that define access to real estate listing records. The listing content repository 12 continually updates, modifies, adds and removes real estate listing data to ensure up to date listings. Listing content repository 12 may also maintain a historical record of the data for auditing and control purposes. Real estate participants provide real estate listing data to the listing content repository 12. Real estate participants may set permission attributes associated with the data. System 10 may continually receive real estate listing data for storage in the listing content repository 12. The real estate listing data is associated with permissions data for distribution of the content to destination websites. System 10 provides data feeds including updates, modifications, additions, or deletions to the data maintained in the listing content repository 12. System 10 may record for audit a user's interactions with system 10, usage statistics for destination websites, permission changes, and so on.

At step 104, system 10 registers destination websites. System 10 provides data feeds to populate the destination website with real estate listing data. The destination websites maybe associated with a member, a broker, a franchise, a CAW, or third-party. The data feeds may be generated directly from the listing content repository, content pools (or access modules) generated from the listing content repository 12, and so on. Each destination website may be associated with an operator, website type, destination address (e.g. resource locator), owner and a permission level. The system 10 is operable to define access modules for different types of destination websites. The access modules may include an industry module, a national shared pool, a franchise pool, a member module, a third party pool, and so on. The access modules may continually update as the data set is updated. The associated filters and permissions may also be updated. Other access modules may be development as destination websites register.

At step 106, system 10 receives criteria for the data feeds for a particular destination website. The received criteria may relate to listing attributes of the real estate listing records. For example, the criteria may specify a price range, a location range, an owner, and so on. The criteria may also specify what type of data to provide in association with each real estate listing in the data feed. The destination website is associated with a permissions level that defines access to the listing content repository based on the type of destination website and the access modules. The permission data for the destination website will be processed by system 10 in association with the received criteria in order to generate data feeds for the corresponding destination website.

Other examples of criteria may include transaction type such as sale and rent/lease, price such as a maximum amount and a minimum amount, property type such as residential, recreational, land, agriculture, parking, commercial, ownership type, waterfront status, geographic location, such as city, area, province, owner of listing, geographic coordinates, postal codes, and so on.

At step 108, system 10 generates data feeds of real estate listing data for the particular website by applying said received criteria against the listing records of the listing content repository. System 10 further filters the data structures based on the permissions level associated with the destination website and the permissions control attributes associated with the real estate listing records. System 10 generates data feeds by filtering based on the received criteria and permissions data.

At step 110, system 10 provides the generated data feed of real estate listing data to the corresponding destination website. The format of the data feed may vary depending on the destination website. The data feed may be in a raw and bulk format for a website that implements an additional application layer to interact with the data feed for example.

The system 10 may repeat one or more steps of method 100 to maintain and operate system 10 over time as real estate listing data in the listing content repository 12 is updated.

System 10 generates and provides the data feed to the destination website on a periodic basis in order to provide up to date data to the destination websites. System 10 may push changes immediately to the destination websites.

System 10 is operable to provide an interface module to enable owners of real estate listings to configure attributes about the real estate listings and owners of destination websites to configure criteria for the data feeds. These owners may be referred to as users. Each user may be associated with a role, such as administrator, staff, board/association, brokerage owner, member, and so on. A user may log onto system by providing identification data. System 10 may authenticate the user prior to granting access. Each user and role may be associated with a scope of accessible data. For example, an operator of a destination website may only be permitted to configure criteria for its data feeds and may not be permitted to configure attributes about real estate listings not associated with that user. As another example, owner(s) of a real estate listing may be permitted to configure attributes for that real estate listing but may not be permitted to configure criteria for data feeds for a destination website not associated with that owner. System administrator may be authorized to search for individuals and block their listings from being distributed to any destination website. System administrator may also block destination websites from receiving data feeds.

System may require a user to accept an electronic user agreement prior to adding listings or registering a destination website.

The interface module may enable an owner of real estate listings to view the current attributes for his/her real estate listings including the permissions attributes to determine which destination websites are permitted to access his/her real estate listings.

The interface module may enable an owner to update and modify the current attributes of real estate listings. For example the interface module may display a list of all real estate listings uniquely identified by listing ID. The interface module may enable an owner of real estate listings to search through the owner's listings based on various search criteria, such as, listing ID, created date, brokerage owner, real estate agent, real estate broker, and so on, to identify and configure attributes thereof.

The interface module may enable an operator of one or more destination websites to view its registered destination websites and modify criteria for data feeds for its websites. The interface module also enables an owner of one or more destination websites to update a destination website, add a new destination website or remove a destination website. The notification may be then sent to interested parties where the notification may contain the date the destination website changed, the user that made the change, and the reason for the change.

The interface module may also enable a user to update information associated with their account, including contact name, address, e-mail, phone number, and so on.

System 10 may include an interface module that is operable to allow a brokerage to opt in members of the brokerage and opt out members of the brokerage into system 10. For example, a member may want to the set up a destination website, ‘opt in’ or ‘opt out’ their listings, and configure attributes about their listings.

System 10 is operable to track traffic and usage statistics for destination websites. System 10 aggregates the traffic and user statistics and stores the aggregated data in a reporting repository. System 10 then is operable to generate traffic and usage reports for destination websites using the reporting repository.

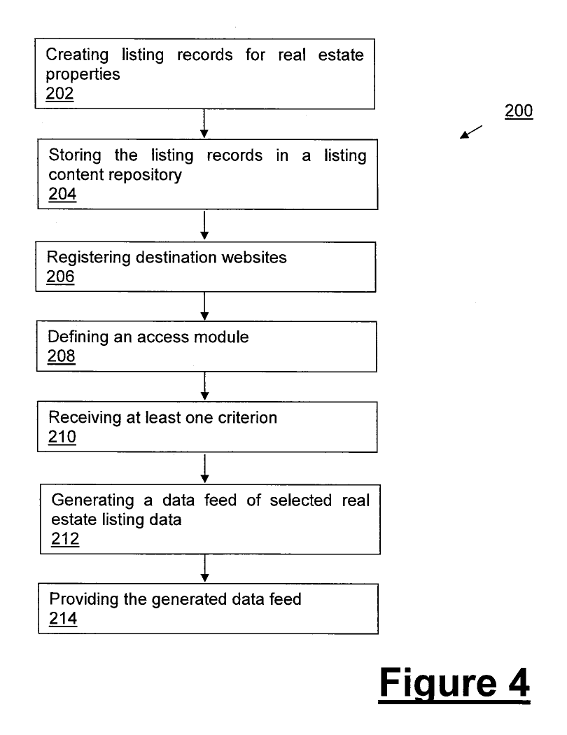

Referring now to FIG. 4, there is shown a block diagram of further details of a method 200 for electronically communicating real estate listing data feeds in accordance with embodiments described herein.

At step 202, system 10 creates a plurality of listing records for a corresponding plurality of real estate properties. Each listing record includes real estate listing data organized as attributes or fields associated with the particular real estate property corresponding to the record. The attributes include permissions attributes defining permissions data. The permissions data defines the access controls associated with the listing record. The permissions data may be specific to a destination website or a type of destination website, or all.

At step 204, system 10 stores the listing records in a listing content repository 12. The listing records may be continually updated, modified, added, removed and so on in the content repository 12.

At step 206, system 10 registers destination websites. Each destination website is associated with a permission level, which defines the scope of listings that may be included in the data feed. The permission level may be correlated with permissions attributes associated with the real estate listings.

At step 208, system 10 defines an access module associated some destination websites. These destination websites may have at least one common permission level, such as all being associated with the same brokerage. The system 10 determines, by a computer processor, a subset of the listing records. The subset of the listing records is determined by filtering the listing records by comparing the common permission level and the permissions attributes in each listing record in the content pool for the data feed.

At step 210, system may receive at least one criterion associated with a destination website that system 10 provides a data feed to. The at least one criterion relates to the real estate listing data, such as price, location, owner, and so on. The data feed is generated using selected real estate listing data computed by applying the criterion against the subset of listing records.

At step 212, system 10 generates a data feed with selected real estate listing data. The selected real estate listing data is generated from the subset of listing records. This includes the data filtered according the permissions levels and criteria.

At step 214, system 10 provides the generated data feed to the destination website, via file transmission, network, or other mechanism.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for electronically communicating real estate listing data feeds, the method comprising:
creating a plurality of listing records for a corresponding plurality of real estate properties, wherein each listing record comprises real estate listing data and a plurality of permissions attributes defining permissions data;
storing the plurality of listing records in a listing content repository;
registering a plurality of destination websites, wherein each destination website is associated with a permission level;
defining an access module associated with a portion of the destination websites, the portion of the destination websites having at least one common permission level, wherein the access module determines, by a computer processor, a subset of the listing records, wherein the subset of the listing records is determined by filtering the plurality of listing records by comparing the at least one common permission level and the permissions attributes in each listing record;
generating a data feed comprising selected real estate listing data, wherein the selected real estate listing data is generated from the subset of listing records; and
providing the generated data feed to the destination website.

2. The method of claim 1 further comprising:
receiving at least one criterion associated with a destination website of the portion of destination websites, wherein the at least one criterion relates to the real estate listing data;
and wherein the selected real estate listing data is generated by applying the at least one criterion against the subset of listing records.

3. The method of claim 2 wherein the at least one criterion is selected from the group consisting of transaction type, price, property type, ownership type, owner, waterfront status, and geographic location.

4. The method of claim 1 wherein the data feed is generated and provided to the destination website on a periodic basis.

5. The method of claim 2 further comprising registering a user associated with one or more destination websites, wherein the user is associated with a role indicating whether the user is permitted to provide the at least one criterion for the destination website.

6. The method of claim 1 further comprising registering a user associated with a listing record, wherein the user is associated with a role indicating whether the user is permitted to set the permissions attributes for the listing record.

7. The method of claim 1 further comprising:
tracking traffic and usage statistics for destination websites and aggregating the traffic and user statistics in a reporting repository;
generating traffic and usage reports for destination websites using the reporting repository.

8. The method of claim 1 wherein the access module comprises a data pool selected from the group consisting a national shared pool, a franchisor pool, a member pool, and a third party pool.

9. A system for generating a customized data feed of real estate listing data for provision to destination websites, the system comprising:
a listing content repository comprising a plurality of listing records for a corresponding plurality of real estate properties, wherein each listing record comprises real estate listing data and a plurality of permissions attributes defining permissions data;
a distribution engine configured to:
register a plurality of destination websites, wherein each destination website is associated with a permission level;
generate a data feed comprising selected real estate listing data; and
provide the generated data feed to a destination website; and
a permission management module configured to define an access module associated with a portion of the destination websites, the portion of the destination websites having at least one common permission level, wherein the access module determines, by a computer processor, a subset of the listing records, wherein the subset of the listing records is determined by filtering the plurality of listing records by comparing the at least one common permission level and the permissions attributes in each listing record;
the selected real estate listing data being generated from the subset of listing records.

10. The system of claim 9 wherein the distribution engine is configured to receive at least one criterion associated with a destination website of the portion of destination websites, wherein the at least one criterion relates to the real estate listing data; and wherein the selected real estate listing data is generated by applying the at least one criterion against the subset of listing records.

11. The system of claim 10 wherein the criteria is configurable and selected from the group consisting of transaction type such as sale and rent/lease; price such as a maximum amount and a minimum amount; property type selected from the group consisting of residential, recreational, land, agriculture, parking, commercial; ownership type; waterfront status; and geographic location.

12. The system of claim 9 wherein the data feed is generated and provided to the destination website on a periodic basis.

13. The system of claim 10 further comprising a registration module to register a user associated with one or more destination websites, wherein the user is associated with a role indicating whether the user is permitted to provide the at least one criterion for the destination website.

14. The system of claim 9 further comprising a registration module to register a user associated with a listing record, wherein the user is associated with a role indicating whether the user is permitted to set the permissions attributes for the listing record.

15. The system of claim 9 further comprising an analytics data module for tracking traffic and usage statistics for destination websites and aggregating the traffic and user statistics in a reporting repository; and generating traffic and usage reports for destination websites using the reporting repository.

16. The system of claim 10 further comprising a security module for authenticating a user prior to receiving the criterion from the user.
